(19) United States
(12) Patent Application Publication
(10) Pub. No.: US 2005/0115455 A1
(43) Pub. Date: Jun. 2, 2005

(54) Guideway for a magnetic levitation train

(76) Inventor: Theodor Baumann, Ismaning (DE)

Correspondence Address: BIRCH STEWART KOLASCH & BIRCH, PO BOX 747, FALLS CHURCH, VA, 22040-0747, US

(21) Appl. No.: 10/995,218

(22) Filed: Nov. 24, 2004

(30) Foreign Application Priority Data
Nov. 28, 2003 (DE) 203 18 423.8

(51) Int. Cl. B60L 13/04

(52) U.S. Cl. 104/281

(57) ABSTRACT

A guideway for a magnetic levitation train includes a levitating structure that is fixedly attached to a magnetic levitation train, and a guideway girder, which in an area that magnetically communicates with the magnetic levitation train is plate-shaped. The guideway girder has laterally protruding edges on which operational components are arranged, a portion of the guideway girder being embraced by the levitation structure in a U-shape. A sound-transmitting gap between end areas of the levitation structure and the guideway girder is formed as a labyrinth to reduce transmission of generated sound.

This nonprovisional application claims priority under 35 U.S.C. § 119(a) to German Patent Application No. 203 18 423.8 filed in Germany on Nov. 28, 2003, which is herein incorporated by reference.

### BACKGROUND OF THE INVENTION

1. Field of the Invention

The present invention relates to a guideway for a magnetic levitation train.

2. Description of the Background Art

Magnetic levitation vehicles require specially designed guideway constructions. As a rule, these include elevated guideway girders, most often designed as single-span beams, that are made of steel, steel-reinforced concrete, or prestressed concrete. These guideway girders have so-called equipment parts, which, in turn, have operation surfaces that are needed for support, guidance, driving, braking, data transmission to the control center, and power supply to the vehicle. These equipment parts are positioned on construction elements that are protruding from the support structure, which are directed towards the outside (external wrap) on guideways for high speed trains, and are directed towards the inside (internal wrap) on guideways for local commuter traffic.

A known guideway for an electromagnetic high speed train has guideway girders made of prestressed concrete (DE 37 16 260 C1) and has a closed, approximately trapezoid-shaped cross-section with an upper cover plate, which on both sides forms plate strips that project from the longitudinal girder sections. In the vicinity of these plate strips, there are operation surfaces, which are formed on stator packets that are mounted underneath the plate strips for the operation of the high speed train, and also on side guide rails, arranged laterally on the plate strips, for side-guiding of the vehicles, and finally on slide surfaces, arranged on the upper side of the guideway girders above the stators, for emergency delevitation movements.

Additionally, a road-level guideway is known, whereby pre-fabricated, disk-shaped guideway elements made of steel-reinforced or pre-stressed concrete, to the longitudinal sides of which the equipment parts with the operation surfaces are attached, are positioned on top of a substructure, which is supported against preferably continuous foundation beams. A primary advantage of such guideway elements that have a limited length, for example, a system measuring approximately 6.2 meters, is the potential of economical serial production while adhering to very small production tolerances.

In any case, it is imperative, in view of the high speed of these vehicles, that the equipment parts bearing the operation surfaces are positioned with extreme accuracy.

Magnetic levitation trains levitate over the guideway without physical contact; they are supported, powered, braked, and guided by magnetic forces. There is only a very minimal gap, a so-called airgap, between the operation surfaces on the guideway and of the vehicle. This eliminates the wheel noise inevitable with wheel-propelled vehicles; however, there, too, is noise emission with magnetic levitation vehicles, the control of which is of importance, particularly with guideway lines that run through populated areas or through nature preservation areas. With magnetic levitation vehicles, the primary source of noise comes from the support and drive system, which include the levitating magnet mounted to the vehicle and the longitudinal stators attached to the guideway. The surface shape of both of these components is aerodynamically unsuitable; they face each other with a minimal distance of the airgap and move against each other at high speed. Apart from the aerodynamic noises thus created, the support system also creates mechanical vibrations with frequencies within the audible range of hearing.

There has been no lack of attempts to lower the sound emission; however, they mostly consisted of reducing the transmission of sound emitted from between the vehicle and the guideway into the surrounding areas by erecting sound-absorbing walls alongside the guideway. It has also been suggested to optimize the shape and texture of the surface of the guideway girders in view of low sound reverberation. In this connection, it has also been learned to arrange sound insulation elements like absorbers or plate resonators on a guideway girder in the area of the upper girder section and/or the lower girder section and/or a supporting section to muffle sound emissions (DE 101 11 919 A1).

Sound-reducing measures such as these or similar forms, which have been known from conventional railways, have the disadvantage that only the sound, which emits from the areas covered by the corresponding sound-absorbing elements, is muffled; however, they are only a part of the sound emissions that occur. In addition, all these sound-absorbing measures are subject to environmental influences, which in the long run may diminish their effectiveness.

### SUMMARY OF THE INVENTION

It is therefore an object of the present invention to provide an economical, but primarily effective and environmentally independent means of noise reduction in the operation of magnetic levitation vehicles.

The invention is based on the idea to insulate the sound at its source, thus avoiding costly measures below and/or alongside the guideway in the field, or on the guideway girders. This is done by utilizing the characteristic of magnetic levitation vehicles, namely, that while in operation, the levitation frame of the vehicles enclosing the operational components follows the geometry of the guideway with only slight deviations measured in millimeters, and that the train body is cushioned against the levitation frame. This constructive special feature of magnetic levitation vehicles, together with their guideways, provides the basic conditions for almost entirely isolating the source of the sound in the supporting system from the environment so that the inevitably generated sound is prevented from reaching the outside.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus, are not limitive of the present invention, and wherein:

FIG. 1 is a cross-section of a conventional elevated guideway for a magnetic levitation train having a guideway girder and depicting reflected sound emissions;

FIG. 2 is a cross-section of a sound absorbing system being provided on an elevated guideway according to an embodiment of the present invention.

FIG. 3 is a cross-section of a conventional road-level guideway for the magnetic levitation train depicting reflected sound emissions; and

FIG. 4 is a cross-section of a sound absorbing system being provided on a road-level guideway, according to an alternate embodiment of the present invention.

### DETAILED DESCRIPTION

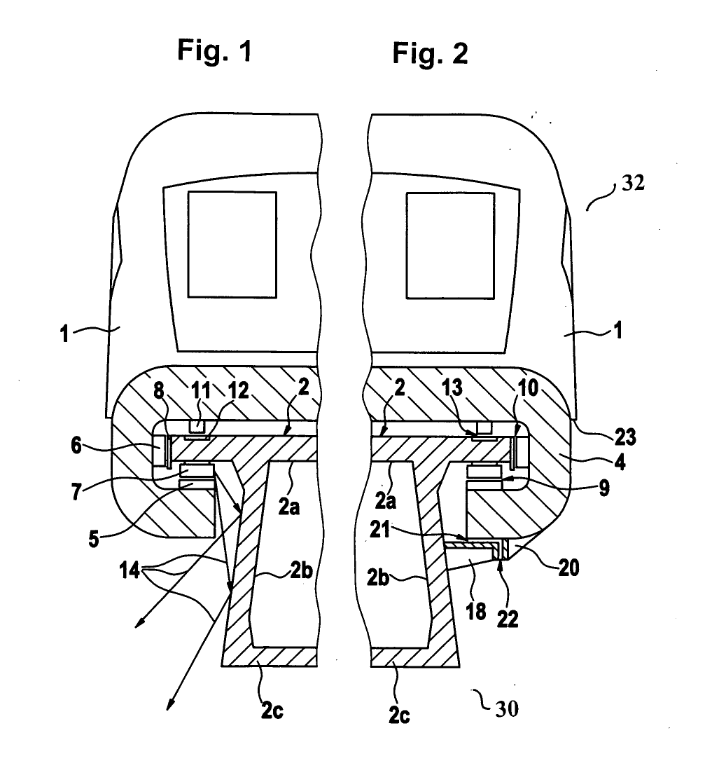

FIG. 1 shows an elevated guideway 30 for a magnetic levitation train 32 that has a guideway girder 2, which are usually single-span beams that are made of steel-reinforced or prestressed concrete. The guideway girder 2 usually is formed to have a closed, box-shaped cross-section. An illustration of the support of the guideway girder 2 against a substructure is omitted in the figures in order to allow a better overview.

On both longitudinal sides of the guideway girder 2, an upper guideway plate 2a extends beyond the box-shaped cross-section, which is formed by transverse girder sections 2b and a bottom plate 2c.

The magnetic levitation train 32 includes a train body 1 and a levitation frame 4. The train body 1 is positioned on top of a levitation frame 4, which embraces lateral sides of the guideway girder 2 in a U-shape. At lower ends of the levitation frame 4, levitation magnets 5 are arranged with guide magnets 6 being arranged on sides of the levitation frame 4. Opposite to the levitation magnets 5 and the guide magnets 6, on the guideway girder 2, lateral stators 7 including stator packets and coils, and side guide rails 8 are arranged. The combined efforts of these elements provide a levitation and guide system that keeps a height of a levitation gap 9 and a width of a side guide gap 10 within very tight limits.

While the levitation frame 4 typically follows the geometry of the guideway during operation, the train body 1 is cushioned against the levitation frame 4 so that the vibrations and joltings produced in the supporting system are highly reduced by the time they reach the vehicle interior. In addition, at a crossover point of the exterior covering of train body 1 and levitation frame 4, the relative shiftings caused by the soft suspension, can be absorbed by a pliant construction 23.

If there is a break-down of the supporting system, the levitation frame 4 lowers itself, through skids 11, onto slide rails 12, which are integrated in an upper side of the guideway girder 2. The magnetic levitation train 32 is thereby delevitated by a defined delevitation value 13.

Arrows 14 illustrate a reflection and transmission of generated sound waves, which are transmitted downwards and outwards, between the magnetic levitation train 32 and the elevated guideway 30.

FIG. 2 illustrates an embodiment of the present invention, in which the generated sound waves are dampened and insulated. The basis of this solution is the appropriate utilization of the special characteristics of the magnetic levitation train and the supporting system.

In contrast to the conventional magnetic levitation train 32, whereby the sound emission from the supporting system (arrows 14) is reflected through the external surface of the girder section 2b and is transmitted into the surrounding areas, the present invention provides for an insulation of the origin of the sound in the supporting system. The fact is utilized that during operation of the magnetic levitation train 32, the levitation frame 4 follows the geometry of the guideway 30 with only minimal deviations (measured in millimeters). This allows a reduction of the gap between the guideway girder 2 and the levitation frame 4 to be formed as a narrow, labyrinth-like gap. In the embodiment shown in FIG. 2, this is accomplished by a longitudinal, angular component 18 that extends parallel to the guideway girder 2 being mounted to the outside of the girder section 2, and by a panel-like component 20, which is mounted to an underside of the levitation frame 4. During installation to the guideway girder 2, the components 18 are adjusted in such a way that, like the levitation frame 4, they follow the geometry of the guideway substantially exactly.

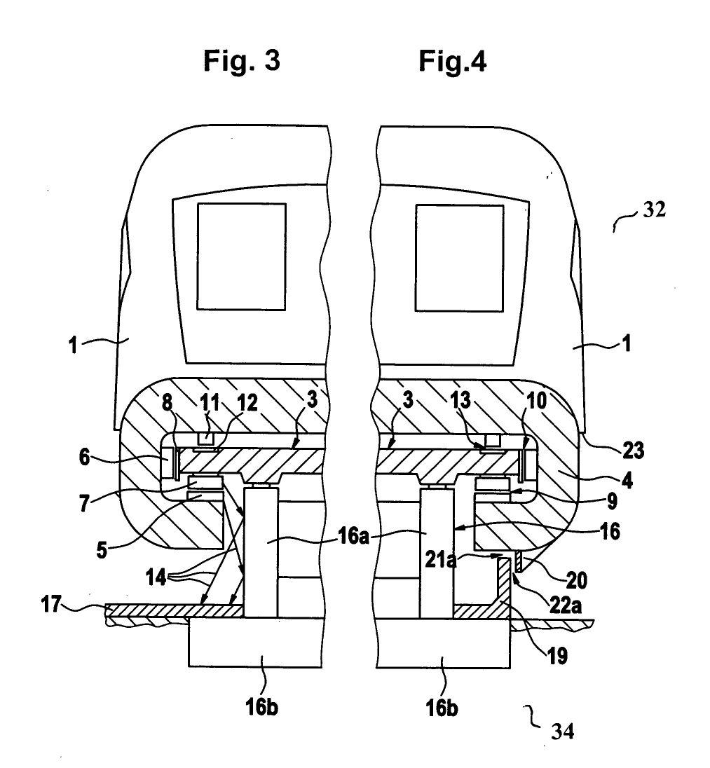

The measurements, namely a height 21 and a width 22 of the labyrinth-like gap thus created between the guideway girder 2 and the levitation frame 4, are determined by the size of the levitation value 13 available between the delevitation skids 11 on the vehicle and the slide rails 12, and the size of the side guide gap 10, enlarged by the required tolerance measurements.

Whereas in FIGS. 1 and 2, an elevated guideway 30 with box-shaped guideway girders 2 is illustrated, FIGS. 3 and 4 illustrate a cross section of a road-level guideway 34. In contrast to the elevated guideway 30, the road-level guideway 34 has guideway plates 3, which can be made of steel-reinforced or prestressed concrete, positioned on top of a substructure 16, which is made of disk-like longitudinally extending support elements 16a, which in turn are supported by foundation beams 16b. It is noted that like reference numerals in the figures represent like parts.

FIG. 3 generally illustrates, by arrows 14, the sound emitted from a conventional road-level guideway 34, whereby it is also known to only place sound-absorbing plates 17, to reduce sound, in the areas alongside the road-level guideway 34. These sound-absorbing plates 17, however, do not satisfactorily absorb the generated sound and therefore, additional large sound protection walls (not shown) have to be provided along either side of the magnetic levitation train 32.

FIG. 4 illustrates an alternate embodiment of the present invention, in which an angular component 19 with a horizontal shank extending parallel to the substructure 16 is positioned on top of the foundation beam 16b, whereas the vertical shank, together with the panel-like component 20 that is mounted to the levitation frame 4, forms a narrow, labyrinth-like gap, the height 21a and width 22a of which is determined by the delevitation value 13 and the side guide gap 10, both being enlarged by the required tolerance measurements.

The exact shape of the labyrinth-like gap that is formed by the components 18, or 19 and 20, is to be determined in accordance with the acoustic and constructive requirement of each individual case. The angular shape of the gap formed by level surfaces in FIGS. 1 and 2 only serves as an example.

The surfaces of the components 18, or 19 and 20 facing the gap can be further equipped with special sound-absorbing features. To prevent the buildup of unacceptable sub- or super pressures at high vehicle speeds, the components 18, or 19 and 20, can be perforated if the need arises. In order to avoid icing over during the winter months, the components may be heated, for example, with heating wires, to keep the temperature of these components above the freezing point.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A guideway for a magnetic levitation train, comprising:
a levitating structure that is fixedly attached to a magnetic levitation train; and
a guideway girder, which in an area that magnetically communicates with the magnetic levitation train is plate-shaped, the guideway girder having laterally protruding edges on which operational components are arranged, a portion of the guideway girder being embraced by the levitation structure in a U-shape,
wherein a sound-transmitting gap between end areas of the levitation structure and the guideway girder is formed as a labyrinth to reduce transmission of generated sound.

2. The guideway according to claim 1, wherein a height and a width of the sound-transmitting gap substantially correspond with tolerance measurements of a levitation gap formed during an operation of the magnetic levitation train.

3. The guideway according to claim 1, wherein the sound-transmitting gap is delimited by level surfaces.

4. The guideway according to claim 1, wherein the sound-transmitting gap has an angular shape.

5. The guideway according to one of claim 1, wherein the sound-transmitting gap is formed by components extending alongside the guideway, the components being arranged on both the guideway girder and the levitation structure.

6. The guideway according to claim 5, wherein at least a portion of surfaces of the components facing the sound-transmitting gap are sound-absorbing.

7. The guideway according to claim 5, wherein the components are perforated.

8. The guideway according to claim 5, wherein the components are heatable.

9. The guideway according to claim 1, wherein the levitating structure is made of steel-reinforced concrete or prestressed concrete.

10. The guideway according to claim 1, wherein the operational components include slide rails, stators, or side guide rails.

11. The guideway according to claim 2, wherein the levitation gap is formed between a skid and slide rails, the skid being fixedly attached to the levitation structure and the slide rails being provided on the guideway girder.

12. The guideway according to claim 2, wherein the levitation gap is formed on the basis of a gap formed between levitation magnets and guide magnets and lateral stators and side guide rails, the levitation magnets and guide magnets being provided on the levitation structure and the lateral stators and side guide rails being provided on the guide girder.

13. A magnetic levitation train system comprising:
a train body;
a levitation frame being attached to the train body;
a guideway being formed to magnetically support the levitation frame thereon such that a levitation gap is formed between the train body and the guideway during an operation of a magnetic levitation train;
a panel being provided on the levitation frame, the panel extending from a lower surface of the levitation frame, the panel having a first exposed surface; and
a cover element being provided on the guideway, the cover element having a second exposed surface,
wherein a sound-transmission gap is formed between the first exposed surface and the second exposed surface, and
wherein the sound transmission gap has a width that is substantially equal to the predetermined levitation gap.

14. The magnetic levitation train system according to claim 13, wherein the sound transmission gap substantially prevents sound waves, which are generated between the levitation frame and the guideway, from propagating beyond the sound transmission gap.

15. The magnetic levitation train system according to claim 13, wherein a minimum vertical gap between the cover element and the levitation frame is based on a distance formed between the levitation frame and the guideway when the levitation frame directly contacts the guideway.

16. The magnetic levitation train system according to claim 13, wherein a minimum horizontal gap between the cover element and a surface of the panel is based on a maximum distance formed between the levitation frame and the guideway when the magnetic levitation train is in operation.
